(19) United States
(12) Patent Application Publication
(10) Pub. No.: US 2014/0258023 A1
(43) Pub. Date: Sep. 11, 2014

(54) Intelligent Personal Finance Tracking Engine

(71) Applicant: BANK OF AMERICA CORPORATION, Charlotte, NC (US)

(72) Inventors: David Joa, San Bruno, CA (US); Timothy J. Bendel, Charlotte, NC (US)

(73) Assignee: Bank of America Corporation, Charlotte, NC (US)

(21) Appl. No.: 13/793,657

(22) Filed: Mar. 11, 2013

(51) Int. Cl. G06Q 40/00

(52) U.S. Cl. CPC G06Q 40/00
USPC 705/26.7; 705/35

(57) ABSTRACT

A system may include a processor coupled to a memory. The processor is capable of determining a first goal adjustment based at least in part upon inflow information, outflow information, financial information, product information, and a customer goal. The processor is also operable to determine a second goal adjustment based at least in part upon inflow information, outflow information, financial information, product information, and a customer goal. Finally, the processor is operable to communicate the first goal adjustment and the second goal adjustment, using a network interface, to the customer.

### TECHNICAL FIELD OF THE INVENTION

The present invention relates generally to the field of customer transactions and more particularly to an intelligent personal finance tracking engine.

### BACKGROUND

As enterprises increase the quantity of instruments and services that users may use to spend and make money, the complexity in tracking all of the financial actions of a user also increases. Users may desire for enterprises to dynamically track the impact that potential user actions may have on a user's particular financial goals.

### SUMMARY

According to embodiments of the present disclosure, disadvantages, and problems associated with previous intelligent personal financial tracking engines may be reduced or eliminated.

In certain embodiments, a system may include a memory and a processor communicatively coupled to the memory. The processor is operable to retrieve economic information and retrieve a customer account associated with a customer. The processor is also operable to retrieve inflow information associated with the customer account and retrieve outflow information associated with the customer account. The processor may also retrieve financial information associated with the customer account, retrieve at least one customer goal associated with the customer account, and retrieve product information. The processor is further operable to determine a first goal adjustment based at least in part upon the inflow information, the outflow information, the financial information, the product information, and the at least one customer goal. The processor is also operable to determine a second goal adjustment based at least in part upon the inflow information, the outflow information, the financial information, the product information, and the at least one customer goal. Finally, the processor is operable to communicate the first goal adjustment and the second goal adjustment, using a network interface, to the customer.

Certain embodiments of the present disclosure may provide some, none, or all of the following technical advantages. For example, in certain embodiments, a personal finance tracking system can be utilized to dynamically provide goal adjustments to a customer, thereby reducing the computational resources, bandwidth, and number of components consumed by older systems which lacked the flexibility to track financial actions of the customer and provide goal adjustments according to the present disclosure. Another advantage is, in certain embodiments, a personal finance tracking system may obtain and retrieve data and provide dynamic goal adjustments to a customer without relying solely on data entry by the customer, thereby reducing the computational resources, bandwidth, and number of components required for previous systems. Additionally, in certain embodiments, a personal finance tracking system is flexible enough to detect and communicate recommendations to a customer to help the customer achieve financial goals faster, thereby reducing the bandwidth, computational resources, and personnel hours required to track financial goals in previous systems.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates an example personal finance tracking system;

FIG. 2 illustrates an example method for personal finance tracking, which may be performed by the example system of FIG. 1 according to certain embodiments of the present disclosure; and

FIG. 3 illustrates a particular embodiment for the example method of FIG. 2, which may be performed by the example system of FIG. 1 according to certain embodiments of the present disclosure.

### DETAILED DESCRIPTION

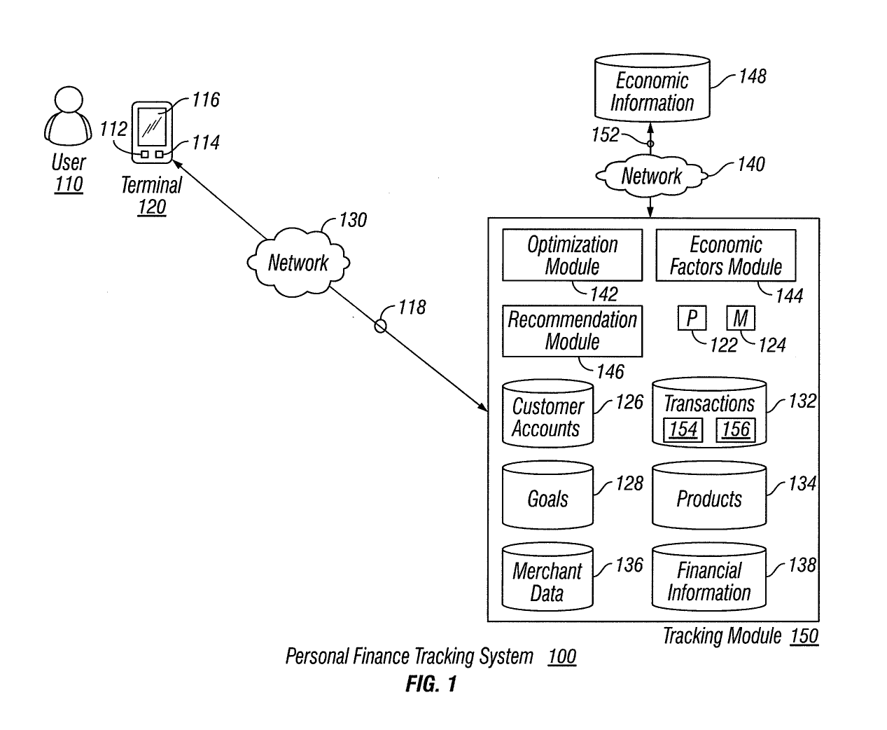

Certain embodiments of the present disclosure provide techniques for intelligently tracking personal finances. FIGS. 1 through 3 below illustrate systems and methods for intelligent personal finance tracking.

FIG. 1 illustrates an example personal finance tracking system. In general, enterprises, such as financial institutions, may offer a dynamic personal finance tracking system to a user. The user may use the personal finance tracking system to track purchases, payments, investments, debts, and/or any other personal finance information. The user may also use the personal finance tracking system to track personal financial goals. The personal finance tracking system may use any of the information available to it to determine probabilities of the user achieving various goals. The personal finance tracking system may use any of the information available to it to determine a possible impact to any particular personal finance goal based on a potential financial transaction executed by the user. The personal finance tracking system may present to the user multiple scenarios of impact to a particular personal finance goal based on a variety of potential financial transactions that may be available to the user.

In particular, personal finance tracking system 100 comprises user 110, terminal 120, networks 130 and 140, and tracking module 150. User 110 may be any customer that intends to track financial goals and information. Although personal finance is discussed, user 110 may be a person or an institution tracking financial goals and information for any suitable purpose. User 110 may use terminal 120 to track financial goals and information. Terminal 120 may be any device capable of providing functionality to, being operable for a particular purpose, or otherwise used by user 110 to access particular functionality of personal finance tracking system 100. Terminal 120 may be operable to communicate with network 130, tracking module 150, and/or any other component of personal finance tracking system 100. As an example, terminal 120 may be a laptop computer, desktop computer, terminal, kiosk, personal digital assistant (PDA), cellular phone, tablet, portable media player, smart device, smart phone, or any other device capable of electronic communication.

In certain embodiments, terminal 120 used by user 110 may include one or more processors 112, one or more memories 114, one or more displays, one or more interfaces, one or more components capable of inputting data, one or more components capable of outputting data, one or more components capable of communicating with any other component of personal finance tracking system 100, or any other component suitable for a particular purpose. Communication may be accomplished wirelessly or via wireline and may be in the form of an e-mail, SMS text message, an instant message, a packet according to a network protocol, and/or any other suitable message format. According to certain embodiments, terminal 120 may include a unique device identifier that differentiates terminal 120 from any other terminal 120 in the example system.

In some embodiments, terminal 120 also may comprise graphical user interface (GUI) 116. GUI 116 is generally operable to tailor and filter data presented to user 110. GUI 116 may provide user 110 with an efficient and user-friendly presentation of information regarding the functionality of terminal 120. GUI 116 may comprise a plurality of displays having interactive fields, pull-down lists, and buttons operated by user 110. GUI 116 may include multiple levels of abstraction including groups and boundaries. In certain embodiments, GUI 116 may comprise a web browser. In another embodiment, GUI 116 may comprise a graphical representation of a mobile application.

At certain times, terminal 120 may attempt to communicate with tracking module 150 over network 130 and/or network 140. Network 120 facilitates wireless or wireline communication. Networks 130 and 140 may communicate, for example, IP packets, Frame Relay frames, Asynchronous Transfer Mode (ATM) cells, voice, video, data, and other suitable information between network addresses. Networks 130 and 140 may include one or more personal area networks (PANs), local area networks (LANs), a wireless LAN (WLAN), a virtual private network (VPN), radio access networks (RANs), metropolitan area networks (MANs), wide area networks (WANs), mobile networks (e.g., using WiMax (802.16), WiFi (802.11), 3G, 4G, or any other suitable wireless technologies in any suitable combination), all or a portion of the global computer network known as the Internet, an extranet, a satellite network, and/or any other communication system or systems at one or more locations, any of which may be any suitable combination of wireless and wireline.

Generally, user 110 may use network 130 to interact with a financial institution. For example, a financial institution may provide access to a variety of financial data to user 110 using tracking module 150. Tracking module 150 may store information about user 110's purchases, debts, loans, investments, spending, or any other suitable information suitable for a particular purpose. User 110 may use terminal 120 to interact with tracking module 150 in order to create, access, or modify goals 128. Tracking module 150 may then present the effect of various factors and potential actions on particular goals 128 to user 110.

More specifically, tracking module 150 may comprise processor 122, memory 124, customer accounts 126, goals 128, transactions 132, products 134, merchant data 136, financial information 138, optimization module 142, economic factors module 144, and recommendation module 146. Processor 122 may include one or more microprocessors, controllers, or any other suitable computing devices or resources. Processor 122 may work, either alone or with components of personal finance tracking system 100, to provide a portion or all of the functionality of personal finance tracking system 100 described herein. For example, in some embodiments, processor 122 may provide functionality for optimization module 142, economic factors module 144, and/or recommendation module 146.

Processor 122 may be configured to handle messages 118 and 152 associated with customer accounts 126, goals 128, transactions 132, products 134, merchant data 136, financial information 138, optimization module 142, economic information 148, economic factors module 144, and/or recommendation module 146. In particular embodiments, processor 122 may be configured to send and receive messages 118 to and from terminal 120. Messages 118 may request and/or send information about any suitable component of personal finance tracking system 100. Processor 122 communicatively couples to memory 124. Memory 124 may take the form of volatile or non-volatile memory including, without limitation, magnetic media, optical media, Random Access Memory (RAM), Read Only Memory (ROM), removable media, or any other suitable memory component. In certain embodiments, a portion or all of memory 124 may store one or more database data structures, such as one or more structured query language (SQL) servers or relational databases.

In certain embodiments, memory 124 may be internal or external to processor 122 and may include one or more instruction caches or one or more data caches. Instructions in the instruction caches may be copies of instructions in memory 124, and the instruction caches may speed up retrieval of those instructions by processor 122. Data in the data caches may include any suitable combination of copies of data in memory 124 for instructions executing at processor 122 to operate on, the results of previous instructions executed at processor 122 for access by subsequent instructions executing at processor 122, or for writing to memory 124, and/or any other suitable data. The data caches may speed up read or write operations by processor 122.

Tracking module 150 may include customer accounts 126, which contain data that may be used by any suitable component of personal finance tracking system 100. Generally, customer accounts 126 contain information about users 110 that may use various services by an enterprise. In particular, customer accounts 126 may include data associated with one or more users 110. Customer accounts 126 may contain information such as unique customer identifier, customer name, user credentials, customer address, email address, customer preferences, credit agency/score, geography data associated with a user 110, social security number, account numbers, household information, age, job title, employer, investment risk profile and/or any other information useful for personal finance tracking as appropriate. In certain embodiments, customer accounts 126 may be stored in one or more text files, tables in a relational database, or any other suitable data structure capable of storing information.

Tracking module 150 may also include goals 128. Goals 128 may be any financial goal that may be associated with a particular user 110. Examples of particular goals 128 are reducing a particular type of spending, purchasing a new good or service, saving a certain amount of money, paying off a certain debt, or any other suitable goal 128 that may be associated with the financial status of a user 110. In some embodiments, there may be a time frame associated with a particular goal 128. In other words, user 110 may desire to reach goal 128 in a certain number of days, weeks, months, years, or any other unit of time measurement. According to some embodiments, more than one goal 128 may be associated with a particular user 110. In such embodiments, user 110 may associate a priority ranking to each goal 128 associated with the user 110 indicating, for example, that the optimization of a first goal 128 is a higher priority than the optimization of a second goal 128. User 110 may create, modify, or otherwise manage goals 128 and/or associated priority rankings using terminal 120. In some embodiments, goals 128 may be stored in one or more text files, tables in a relational database, or any other suitable data structure capable of storing information.

Tracking module 150 is capable of determining the probability that user 110 may achieve a particular goal 128. Generally, tracking module 150 may include optimization module 142, which can generate various scenarios and probabilities to facilitate optimal budgeting guidance to help users 110 meet certain goals 128. More specifically, optimization module 142 may be any software, hardware, firmware, or combination thereof capable of determining the probabilistic impact a certain scenario may have on a particular goal 128 for user 110. For example, optimization module 142 may determine that if user 110 reduces a particular amount of spending by a certain amount, based on a variety of factors, the likelihood or probability of user 110 reaching a specific goal 128 may increase. Any priority ranking associated with the specific goal 128 may be a factor considered by optimization module 142. As another example, optimization module 142 may determine how purchasing a particular good or service (e.g., product 134) over a comparable good or service may impact the probability that user 110 reaches a particular goal 128. In certain embodiments, optimization module 142 may determine an impact on a particular goal 128 based on a total cost amount independent of a specific product 134. According to some embodiments, optimization module 142 may be able to quantify an impact on a particular goal 128 by determining a probability score for user 110 reaching a particular goal 128.

To perform some of its functionalities, optimization module 142 may access transactions 132. Examples of transactions 132 may be a purchase, a credit, a debit, a balance transfer, a payment due, a rejected payment, a financial fee, and/or any other financial transaction suitable for a particular purpose. For a particular transaction 132, transactions 132 may include information regarding transaction amount, transaction date, transaction type, transaction channel, financial instrument, transaction due date, transaction description, transaction location, or any other suitable information about a particular transaction 132. In certain embodiments, transactions 132 may be stored in one or more text files, tables in a relational database, or any other suitable data structure capable of storing information. Transactions 132 may be created based on input received from user 110, information received from merchants, information available to the financial institution (e.g. checking account information), or any other suitable financial transaction information source. Optimization module 142 may be capable of categorizing and ranking transactions 132 that may be used to calculate goal adjustments to particular goals 128.

In the illustrated embodiment, transactions 132 include inflow information 154 and outflow information 156. Inflow information 154 may be information about any source of income that user 110 may receive. For example, inflow information 154 may be information regarding a direct deposit into an account associated with user 110, interest earned by user 110, an annuity associated with user 110, or any other income associated by user 110. Optimization module 142 may also access outflow information 156 to perform some of its functions. Outflow information 156 may be any spending associated with user 110. For example, outflow information 156 may be bills paid by user 110, goods and services bought by user 110, deposits made into an investment account associated with user 110, deposits made into a retirement account associated with user 110, or any other expense by user 110. In order to determine an adjustment to a particular goal 128 based on a potential action by user 110, optimization module 142 may also access products 134. Generally, products 134 may be any good or service that may be purchased, or otherwise acquired, by user 110. For example, products 134 may be deposit products, investment products, credit products, loan products, retail products, or any other suitable product. Products 134 may be offered by the enterprise or they may be offered by a third party. Products 134 may include any suitable information pertaining to a particular product 134 such as a name, a type, an identifier, a cost, a location, offering merchant, or any other suitable product detail. In some embodiments, products 134 may be stored in one or more text files, tables in a relational database, or any other suitable data structure capable of storing information.

Particular products 134 may be offered for sale by certain merchants. Information about merchants may be stored in merchant data 136. Generally, merchant data 136 may be any suitable information pertaining to a particular merchant. More specifically, merchant data 136 may include information regarding the merchant location (e.g., longitude and latitude), address, name, sales volume, merchant identifier, owner, business type, point of sale terminal identifiers, suppliers, customers, and/or any other suitable merchant information.

Optimization module 142 may also access financial information 138 to provide some of its functionalities. Financial information 138 is information about any financial account that may be associated with user 110. Financial information 138 may include general information about financial accounts such as account type, account open date, average balance, current balance, fees, daily closing balance, interest rate, account owner, ownership type, or any other suitable information about any financial account that may be associated with user 110. In certain embodiments, financial information 138 may be stored in one or more text files, tables in a relational database, or any other suitable data structure capable of storing information.

Financial information 138 may also include information specific to a particular type of financial account. Some examples of types of financial accounts are loans and consumer credit accounts, deposit accounts, and investment accounts. Example information pertaining to loans and consumer credit accounts may be loan or credit type, annual percentage rate (APR), payment cycle date, minimum payment, promotional APR, promotional APR expiration, escrow balance, interest payment, interest paid to date, outstanding balance, loan terms, remaining number of payments, rewards, redeemed rewards, accumulated rewards, contact history, or any other suitable information regarding a loan or consumer credit account. Example information pertaining to deposit accounts may include deposit account type (e.g., savings, checking, money market, etc.), overdraft protection indicator, number of prior overdrafts, domiciling banking center, interest rate, interest earned, payee name, payer name, direct deposit indicator, or any other suitable information regarding deposit accounts. Example information pertaining to investment accounts may be a risk profile, a securities or investment identifier, a dividend from securities, service level qualifiers, accrued income, or any other suitable information regarding investment accounts. Any particular financial transaction associated with an account with information stored in financial information 138 may be included in transactions 132.

According to some embodiments, optimization module 142 may access economic information 148. Economic information 148 may be any data that may provide information regarding the economic condition of a country, market, industry, institution, and/or any other suitable entity. For example, economic information 148 may include government economic data and statistics. Government economic data and statistics may include unemployment rate, consumer price index, Federal Reserve System rates, or any other suitable economic data released by a government. Economic information 148 may also include data related to market conditions such as interest rates, inflation rates, stock market pricing, pricing of publicly traded instruments, or any other suitable market condition data. In certain embodiments, economic information 148 may also include data internal or external to a particular financial institution such as analysts' projections, market pricing sheets, federal fund rate bids, competitor rates, or any other suitable financial data.

Economic information 148 may be stored in one or more text files, tables in a relational database, or any other suitable data structure capable of storing information. Economic information 148 may be stored in memory 124 of tracking module 150 or it may be accessed from an external source. Tracking module 150 may use economic factors module 144 to facilitate the gathering of economic information 148. More specifically, economic factors module 144 may be any software, hardware, firmware, or combination thereof capable of gathering any suitable financial information that may be included in economic information 148. According to some embodiments, economic factors module 144 may gather information from publicly accessible websites. In such embodiments, economic factors module 144 may be able to access certain websites and extract particular economic factors information from the websites that may be used by any suitable component of tracking module 150. In particular embodiments, economic factors module 144 may access economic information 148 stored externally to tracking module 150 by communicating message 152 over network 140. For example, economic factors module 144 may be able to retrieve economic information 148 using an application programming interface (API).

In some embodiments, tracking module 150 may include recommendation module 146. Generally, recommendation module 146 may analyze the transaction history of a particular user 110 and determine an adjustment may be made to the financial habits of user 110. More specifically, recommendation module 146 may be any software, hardware, firmware, or combination thereof capable of gathering suitable information and determining adjustments that can be made to the financial habits of user 110 to improve the probability that user 110 may reach a particular goal 138. For example, recommendation module 146 may access transactions 132 and determine that user 110 is spending too much money on auto repairs. Recommendation module 146 may determine that user 110 is more likely to achieve a particular goal 138 if user 110 purchases a new car. In certain embodiments, recommendation module 146 may retrieve information from merchant data 136, customer accounts 126, products 134, and/or any other suitable component of personal finance tracking system 100 and provide a purchase recommendation to user 110 based at least in part upon the retrieved information. As an example, recommendation module 146 may use location information associated with user 110 to determine the best car purchasing options for user 110 in a particular geographical area. As another example, recommendation module 146 may provide different scenarios to user 110 for a home loan refinance (e.g., zero cost refinance, refinance with cash out option, lower APR with higher closing costs, etc.) and the associated goal adjustments to particular goals 128 for each scenario.

The operation of tracking module 150 may now be described with reference to FIG. 1. Generally, user 110 may want to know what impact a potential transaction may have on a certain goal 128 of user 110. User 110 may be at a retail store and seeks guidance on how much to spend at the store, what payment instrument to use, or what product to purchase. Personal finance tracking system 100 may provide guidance by communicating what impact various variables will have on the probability of user 110 achieving a particular goal 128. More specifically, in some embodiments, user 110 may initiate a request for financial guidance by using terminal 120 to communicate message 118 over network 130 to tracking module 150. Message 118 may include information that will allow tracking module 150 retrieve information associated with user 110. According to certain embodiments, tracking module 150 may initiate financial guidance based on a particular location of user 110. As an example scenario, user 110 may desire to know how a particular purchase at a coffee shop may impact a particular goal 128.

After financial guidance is initiated, tracking module 150 may access information that can be used to calculate a goal adjustment to a particular goal 128. In particular, optimization module 142 may retrieve customer account information from customer accounts 126, inflow information 154 from transactions 132, outflow information 156 from transactions 132, financial information 138, customer goal information from goals 128, merchant information from merchant data 136, and/or product information from products 134. Optimization module 142 may also retrieve economic information 148. In some embodiments, optimization module 142 may request economic information 148 from economic factors module 144. In response, economic factors module 144 may communicate message 152 over network 140 requesting access to economic information 148. For example, economic factors module 144 may be able to retrieve economic information 148 using an application programming interface. According to certain embodiments, economic factors module 144 may gather information from publicly accessible websites. In such embodiments, economic factors module 144 may be able to access certain websites and extract particular economic factors information from the websites that may be used by any suitable component of tracking module 150.

Once data is retrieved, optimization module 142 may determine a first goal adjustment to a particular goal 128. Optimization module 142 may determine a first goal adjustment based at least in part upon inflow information 154, outflow information 156, financial information 138, product information from products 134, goal information from goals 128, merchant information from merchant data 136 and/or any other suitable information. For example, based on accessed information, optimization module 142 may determine a change in probability for user 110 achieving a particular goal 128 if user 110 undertakes a first potential action. A first potential action may be purchasing a first product 134, spending a first amount of money, using a first payment instrument, spending money at a first merchant, or any other financial action a user 110 may potentially take. In the example scenario above, a first goal adjustment for a particular goal 128 may be calculated for a first amount that user 110 may spend at the coffee shop. It may take into account outstanding balances belonging to user 110, interest rates for those balances, the effect of the purchase on the savings of user 110, or any other information tracked in personal finance tracking system 100.

Optimization module 142 may also determine a second goal adjustment to a particular goal 128 to provide user 110 with information indicating how different actions will affect the probability of achieving the particular goal 128. Optimization module 142 may determine a second goal adjustment based at least in part upon inflow information 154, outflow information 156, financial information 138, product information from products 134, goal information from goals 128, merchant information from merchant data 136, and/or any other suitable information. For example, based on accessed information, optimization module 142 may determine a change in probability for user 110 achieving a particular goal 128 if user 110 undertakes a second potential action. A second potential action may be purchasing a second product 134, spending a second amount of money, using a second payment instrument, spending money at a second merchant, or any other financial action that may be different than the first potential action a user 110 may take. Continuing the example scenario above, a second goal adjustment for a particular goal 128 may be calculated for a second amount that user 110 may spend at the coffee shop. It may take into account outstanding balances belonging to user 110, interest rates for those balances, the effect of the purchase on the savings of user 110, or any other information tracked in personal finance tracking system 100.

Once the first and second goal adjustments are determined, optimization module 142 may communicate the adjustments to user 110. In particular, optimization module 142 may communicate message 118 to terminal 120 over network 130. Message 118 may include information pertaining to the first and second goal adjustments. For example, the goal adjustments may be a probability score for the probability of user 110 achieving a particular goal 138 if a particular action is taken. Communication of message 118 may be accomplished wirelessly or via wireline and may be in the form of an e-mail, SMS text message, an instant message, a packet according to a network protocol, and/or any other suitable message format.

In certain embodiments, based on retrieved information, tracking module 150 may also offer purchase recommendations to user 110. In particular, recommendation module 146 may access inflow information 154 and outflow information 156 from transactions 132 and determine that user 110 could make adjustments to the financial actions of user 110. Recommendation module 146 may determine that user 110 is more likely to achieve a particular goal 138 if user 110 takes a particular action. In certain embodiments, recommendation module 146 may retrieve information from merchant data 136, customer accounts 126, products 134, and/or any other suitable component of personal finance tracking system 100 and provide a purchase recommendation to user 110 based at least in part upon the retrieved information. As an example, recommendation module 146 may use location information associated with user 110 to determine a purchase recommendation to make to user 110. Once a purchase recommendation has been determined, it may be communicated to user 110. For example, tracking module 150 may communicate a purchase recommendation in message 118 to terminal 120 over network 130.

Any component of personal finance tracking system 100 may include an interface (e.g., network interface), logic, memory, and other suitable elements. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic. Any suitable logic may perform the functions of personal finance tracking system 100.

Certain embodiments of the present disclosure may provide some, none, or all of the following technical advantages. For example, in certain embodiments, personal finance tracking system 100 can be utilized to dynamically provide goal adjustments to a user 110, thereby reducing the computational resources, bandwidth, and number of components consumed by older systems that lacked the flexibility to track financial actions of user 110 and provide goal adjustments according to the present disclosure. Another advantage is, in certain embodiments, personal finance tracking system 100 may obtain and retrieve data and provide dynamic goal adjustments to a user 100 without relying solely on data entry by user 100, thereby reducing the computational resources, bandwidth, and number of components required for previous systems. Additionally, in certain embodiments, personal finance tracking system 100 is flexible enough to detect and communicate recommendations to user 110 to help user 110 achieve goals 128 faster, thereby reducing the bandwidth, computational resources, and personnel hours required to track financial goals in previous systems.

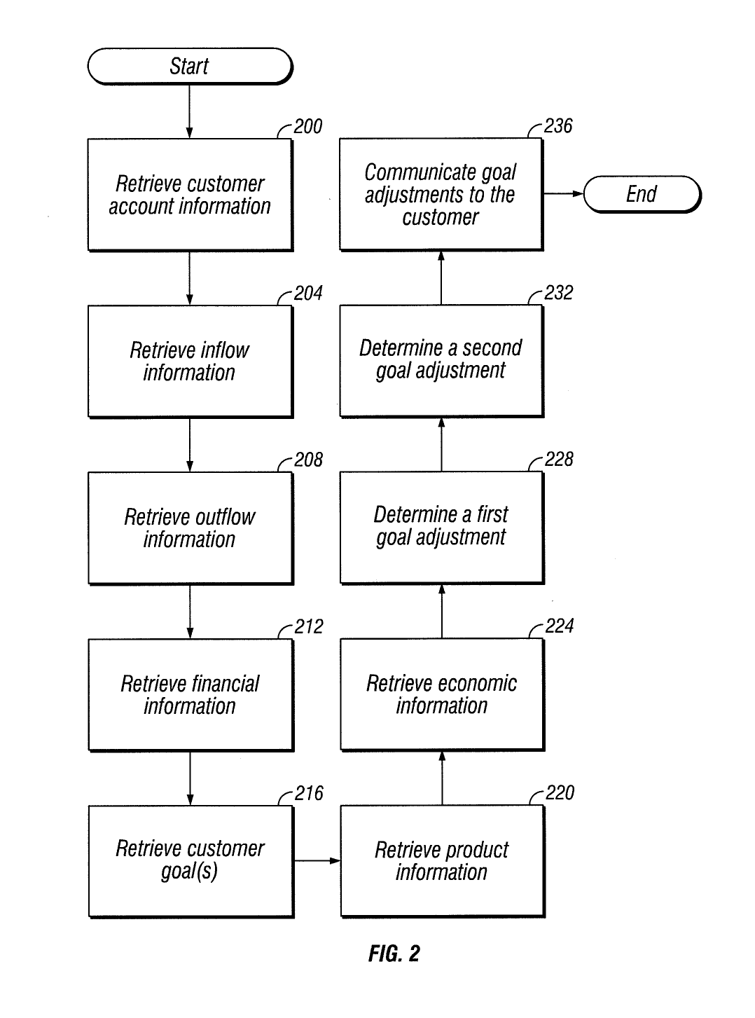

FIG. 2 illustrates an example method for personal finance tracking, which may be performed by the example system of FIG. 1 according to certain embodiments of the present disclosure. The method may be implemented in any suitable combination of software, firmware, and hardware. Although particular components may be identified as performing particular steps, the present disclosure contemplates any suitable components performing the steps according to a particular purpose.

Tracking module 150 may begin to determine goal adjustments to a particular goal 128 by accessing information that can be used to calculate a goal adjustment to a particular goal 128. In particular, at step 200, optimization module 142 may retrieve customer account information from customer accounts 126. At step 204, optimization module 142 may retrieve inflow information 154 from transactions 132. At step 208, optimization module 142 may retrieve outflow information 156 from transactions 132. At step 212, optimization module 142 may retrieve financial information 138. At step 216, optimization module 142 may retrieve customer goal information from goals 128. Next, at step 220, optimization module 142 may retrieve merchant information from merchant data 136, and/or product information from products 134.

At step 224, optimization module 142 may also retrieve economic information 148. In some embodiments, optimization module 142 may request economic information 148 from economic factors module 144. In response, economic factors module 144 may communicate message 152 over network 140 requesting access to economic information 148. For example, economic factors module 144 may be able to retrieve economic information 148 using an application programming interface. According to certain embodiments, economic factors module 144 may gather information from publicly accessible websites. In such embodiments, economic factors module 144 may be able to access certain websites and extract particular economic factors information from the websites that may be used by any suitable component of tracking module 150.

Once data is retrieved, optimization module 142, at step 228, may determine a first goal adjustment to a particular goal 128. Optimization module 142 may determine a first goal adjustment based at least in part upon inflow information 154, outflow information 156, financial information 138, product information from products 134, goal information from goals 128, merchant information from merchant data 136, and/or any other suitable information. For example, based on accessed information, optimization module 142 may determine a change in probability for user 110 achieving a particular goal 128 if user 110 undertakes a first potential action. A first potential action may be purchasing a first product 134, spending a first amount of money, using a first payment instrument, spending money at a first merchant, or any other financial action a user 110 may potentially take. As an example, optimization module 142 may take into account outstanding balances belonging to user 110, interest rates for those balances, the effect of the purchase on the savings of user 110, or any other information tracked in personal finance tracking system 100. After determining a first goal adjustment, the example method may proceed to step 232.

At step 232, optimization module 142 may determine a second goal adjustment to a particular goal 128 to provide user 110 with information indicating how different actions will affect the probability of achieving the particular goal 128. Optimization module 142 may determine a second goal adjustment based at least in part upon inflow information 154, outflow information 156, financial information 138, product information from products 134, goal information from goals 128, merchant information from merchant data 136 and/or any other suitable information. For example, based on accessed information, optimization module 142 may determine a change in probability for user 110 achieving a particular goal 128 if user 110 undertakes a second potential action. A second potential action may be purchasing a second product 134, spending a second amount of money, using a second payment instrument, spending money at a second merchant, or any other financial action that may be different than the first potential action a user 110 may potentially take. As an example, optimization module 142 may take into account outstanding balances belonging to user 110, interest rates for those balances, the effect of the purchase on the savings of user 110, or any other information tracked in personal finance tracking system 100.

Once the first and second goal adjustments are determined, optimization module 142 may communicate the adjustments to user 110 at step 236. In particular, optimization module 142 may communicate message 118 to terminal 120 over network 130. Message 118 may include information pertaining to the first and second goal adjustments. For example, the goal adjustments may be a probability score for the probability of user 110 achieving a particular goal 138 if user 110 takes a particular action. Communication of message 118 may be accomplished wirelessly or via wireline and may be in the form of an e-mail, SMS text message, an instant message, a packet according to a network protocol, and/or any other suitable message format.

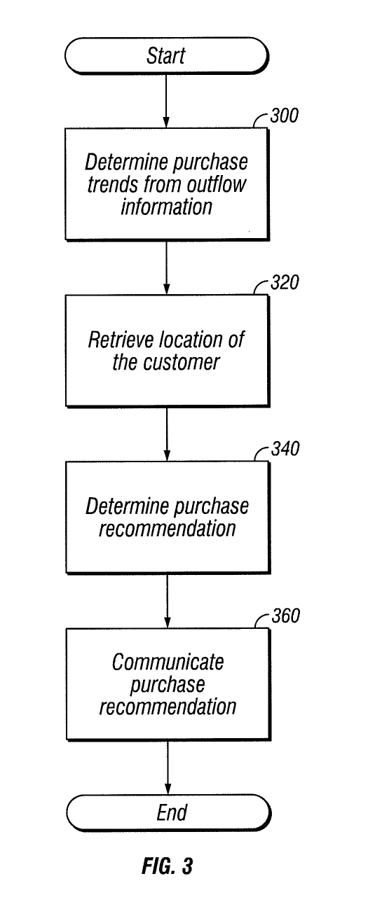

FIG. 3 illustrates a particular embodiment for the example method of FIG. 2, which may be performed by the example system of FIG. 1 according to certain embodiments of the present disclosure. The method may be implemented in any suitable combination of software, firmware, and hardware. Although particular components may be identified as performing particular steps, the present disclosure contemplates any suitable components performing the steps according to a particular purpose.

In certain embodiments, based on retrieved information, tracking module 150 may also offer purchase recommendations to user 110. In particular, the example method may begin at step 300 where recommendation module 146 may access inflow information 154 and outflow information 156 from transactions 132 and determine that user 110 could make adjustments to the financial actions of user 110. For example, recommendation module 146 may determine that user 110 is more likely to achieve a particular goal 138 if user 110 takes a particular action. At step 320, recommendation module 146 may retrieve the location of user 110. For example, recommendation module 146 may obtain location information from customer accounts 126, GPS coordinates provided by terminal 120, an input from user 110, or any other suitable location data source. At step 340, recommendation module 146 may retrieve information from merchant data 136, customer accounts 126, products 134, and/or any other suitable component of personal finance tracking system 100 and provide a purchase recommendation to user 110 based at least in part upon the retrieved information. As an example, recommendation module 146 may use location information associated with user 110 to determine a purchase recommendation to make to user 110. Once a purchase recommendation has been determined, at step 360, it may be communicated to user 110. For example, tracking module 150 may communicate a purchase recommendation in message 118 to terminal 120 over network 130.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as falling within the spirit and scope of the appended claims.

What is claimed is:

1. A system, comprising:
an economic factors module, executed by a processor, operable to retrieve economic information; and
an optimization module, executed by the processor, operable to:
retrieve a customer account associated with a customer;
retrieve inflow information associated with the customer account;
retrieve outflow information associated with the customer account;
retrieve financial information associated with the customer account;
retrieve at least one customer goal associated with the customer account;
retrieve product information;
determine a first goal adjustment based at least in part upon the inflow information, the outflow information, the financial information, the product information, and the at least one customer goal;
determine a second goal adjustment based at least in part upon the inflow information, the outflow information, the financial information, the product information, and the at least one customer goal; and
communicate the first goal adjustment and the second goal adjustment, using a network interface, to the customer.

2. The system of claim 1, wherein retrieving economic information comprises retrieving economic information using an application programming interface.

3. The system of claim 1, wherein the economic factors module is further operable to retrieve economic information from a third party information source.

4. The system of claim 3, wherein the third party information source is a website operated by a third party.

5. The system of claim 1, wherein retrieving product information is based at least in part upon a current location of the customer.

6. The system of claim 1, further comprising a recommendation module, executed by the processor, operable to:
determine a purchase recommendation based at least in part upon the outflow information, the product information, and the at least one customer goal; and
communicate the purchase recommendation to the customer.

7. The system of claim 6, wherein determining the purchase recommendation is further based at least in part on a current location of the customer.

8. A system, comprising:
a memory; and
a processor communicatively coupled to the memory, the processor operable to:
retrieve economic information;
retrieve a customer account associated with a customer;
retrieve inflow information associated with the customer account;
retrieve outflow information associated with the customer account;
retrieve financial information associated with the customer account;
retrieve at least one customer goal associated with the customer account;
retrieve product information;
determine a first goal adjustment based at least in part upon the inflow information, the outflow information, the financial information, the product information, and the at least one customer goal;
determine a second goal adjustment based at least in part upon the inflow information, the outflow information, the financial information, the product information, and the at least one customer goal; and
communicate the first goal adjustment and the second goal adjustment, using a network interface, to the customer.

9. The system of claim 8, wherein retrieving economic information comprises retrieving economic information using an application programming interface.

10. The system of claim 8, wherein the processor is further operable to retrieve economic information from a third party information source.

11. The system of claim 10, wherein the third party information source is a website operated by a third party.

12. The system of claim 8, wherein retrieving product information is based at least in part upon a current location of the customer.

13. The system of claim 8, wherein the processor is further operable to:
determine a purchase recommendation based at least in part upon the outflow information, the product information, and the at least one customer goal; and
communicate the purchase recommendation to the customer.

14. The system of claim 13, wherein determining the purchase recommendation is further based at least in part on a current location of the customer.

15. A computer-implemented method, comprising:
retrieving, using a processor, economic information;
retrieving, using the processor, a customer account associated with a customer;
retrieving, using the processor, inflow information associated with the customer account;
retrieving, using the processor, outflow information associated with the customer account;
retrieving, using the processor, financial information associated with the customer account;
retrieving, using the processor, at least one customer goal associated with the customer account;
retrieving, using the processor, product information;
determining, using the processor, a first goal adjustment based at least in part upon the inflow information, the outflow information, the financial information, the product information, and the at least one customer goal;
determining, using the processor, a second goal adjustment based at least in part upon the inflow information, the outflow information, the financial information, the product information, and the at least one customer goal; and
communicating, using the processor, the first goal adjustment and the second goal adjustment, using a network interface, to the customer.

16. The method of claim 15, wherein retrieving economic information comprises retrieving economic information using an application programming interface.

17. The method of claim 15, further comprising retrieving economic information from a third party information source.

18. The method of claim 17, wherein the third party information source is a website operated by a third party.

19. The method of claim 15, wherein retrieving product information is based at least in part upon a current location of the customer.

20. The method of claim 15, further comprising:
determining a purchase recommendation based at least in part upon the outflow information, the product information, and the at least one customer goal; and
communicating the purchase recommendation to the customer.

21. The method of claim 20, wherein determining the purchase recommendation is further based at least in part on a current location of the customer.
